(19) United States
(12) Patent Application Publication
(10) Pub. No.: US 2010/0206394 A1
(43) Pub. Date: Aug. 19, 2010

(54) APPARATUS FOR BLOCKING FLUID FLOW IN A PIPE LINE AND SYSTEM FOR FORMING BYPASS USING THE SAME

(75) Inventors: Ki Ho Song, Chungcheongnam-do (KR); Myung Sup Song, Chungcheongnam-Do (KR)

Correspondence Address: ROSENBERG, KLEIN & LEE, 3458 ELLICOTT CENTER DRIVE-SUITE 101, ELLICOTT CITY, MD, 21043, US

(73) Assignee: GYE MYEONG ENGINEERING CO., LTD., CHUNGCHEONGNAMDO (KR)

(21) Appl. No.: 12/452,681

(22) PCT Filed: Jul. 16, 2008
(86) PCT No.: PCT/KR2008/004169

§ 371 Date: Apr. 30, 2010

(30) Foreign Application Priority Data
Jul. 16, 2007 (KR) 10-2007-0070952
Jul. 16, 2008 (KR) 10-2008-0069052

(51) Int. Cl. F16K 43/00; F16L 55/10

(52) U.S. Cl. 137/315.01; 138/89

(57) ABSTRACT

In a pipeline fluid flow blocking device, a hollow housing unit has a cylindrical shape whose one side is opened and is coupled to a pipeline to communicate with the pipeline. A transfer unit moves in a longitudinal direction of the housing unit inside the housing unit. A first driving unit moves the transfer unit in a gear method. A blocking unit is hinge-coupled to one side of the transfer unit, is disposed to move between the housing unit and the inside of the pipeline through the opened one side of the housing unit by the transfer unit, and is radially expanded or shrunk to shut off the inside of the pipeline. A second driving unit makes the blocking unit be expanded or shrunk. Therefore, as the blocking unit is expanded in a gear method, resistance force against a fluid of very high pressure inside the pipeline is greatly improved, thereby more stably shutting the inside the pipeline.

### TECHNICAL FIELD

The present invention relates to a pipeline fluid flow blocking device for blocking the flow of a fluid which flows in a pipeline and a bypass forming system using the same, and more particularly, to a pipeline fluid flow blocking device for stably blocking the flow of a fluid in a pipe line temporarily during a work for replacing, transferring, repairing and maintaining a pipeline such as a water or sewer pipeline, an oil pipeline, and a gas pipeline and a bypass forming system using the same.

### BACKGROUND ART

Generally, fluids essential to life of human beings such as water, oil, and gas are mechanically transferred through a pipeline from a producing district to its destination. For example, a large number of water and sewer pipelines are installed under a residential place. In order to replace, transfer, repair and maintain a timeworn or water-leaking pipeline, water supply should be first suspended in a broad region.

For example, when a water pipeline in a certain district is timeworn, in order to replace a timeworn water pipeline, a main valve which goes to the district is blocked. For this reason, the whole district connected to the main valve should undergo inconvenience of water supply suspension for a long time, and so the loss cost of the district residents is large.

In order to resolve the above problem, U.S. Pat. Nos. 4,458,721 (Yie, et al) and 5,462,077 (Cohen, et al) disclose device for temporarily blocking a fluid which flows in a pipeline by using an expendable means like an airbag. The airbags of the devices disclosed in U.S. Pat. Nos. 4,458,721 and 5,462,077 are low in durability and so may burst, and so there is a restriction to blocking a high pressure fluid. Therefore, such devices are used restrictedly in a small-bore pipeline in which pressure of a fluid is low.

In order to overcome the above problems, the applicant of the present invention has proposed in Korean Patent Publication No. 2007-34919 and Korean Patent No. 728,766 a devices and a methods for radially expanding an unfolding plate made of metal to block a fluid in a pipeline. However, when shutting off a pipeline installed in lowlands or a large-diameter pipeline, fluid pressure applied to the unfolding plate is as high as 3 kg/cm² to about 20 kg/cm². In this instance, if an unfolding plate is momentarily expanded by the high pressure to impact an inner surface of a pipeline, the pipeline inside may burst. Also, when a pipeline is momentarily shut off by an unfolding plate, a strong vortex occurs inside a pipeline, thereby damaging the inside of a pipeline.

### DISCLOSURE OF INVENTION

### Technical Problem

It is a first object of the present invention to provide a fluid flow blocking device which can block a flow of a fluid which has high pressure inside a pipeline.

It is a second object of the present invention to provide a bypass forming system using the device.

### Technical Solution

In order to achieve the first object, one aspect of the present invention provides a pipeline fluid flow blocking device, comprising: a hollow housing unit having a cylindrical shape whose one side is opened and being coupled to a pipeline to communicate with the pipeline in the one side; a transfer unit for moving in a longitudinal direction of the housing unit inside the housing unit; a first driving unit for moving the transfer unit by using a gear method; a blocking unit which is hinge-coupled to one side of the transfer unit, is disposed to move between the housing unit and the inside of the pipeline through the opened one side of the housing unit by the transfer unit, and is radially expanded or shrunk to shut of the inside of the pipeline; and a second driving unit for performing expanding or shrinking of the blocking unit in a gear method.

According to the exemplary embodiment of the present invention, the transfer unit has a first hole which extends in a longitudinal direction of the transfer unit and has a screw thread formed in its inner surface.

According to the exemplary embodiment of the present invention, the first driving unit comprises a first operation shaft of a screw form which extends in a longitudinal direction of the housing unit and is inserted into the first hole of the transfer unit to move the transfer unit by a screw-thread coupling; and a first torque providing portion for rotating the first operation shaft.

According to the exemplary embodiment of the present invention, the first torque providing portion comprises a decelerating motor.

According to the exemplary embodiment of the present invention, the first driving unit comprises a second torque providing portion disposed apart from the first torque providing portion; a first transmission shaft coupled to the second torque providing portion and disposed in a vertical direction to the first operation shaft; and a first bevel gear for connecting the first transmission shaft and the first operation shaft and transmitting torque generated by the second torque providing portion to the first operation shaft through the first transmission shaft.

According to the exemplary embodiment of the present invention, the pipeline fluid flow blocking device further comprises a clutch means which is coupled to the first operation shaft and connects or separates the first operation shaft to or from the first torque providing portion.

According to the exemplary embodiment of the present invention, the first hole of the transfer unit and the first operation shaft are disposed on a central axis line formed in a longitudinal direction of the housing unit.

According to the exemplary embodiment of the present invention, the transfer unit has a second hole which is apart from the first hole and extends in a longitudinal direction of the transfer unit.

According to the exemplary embodiment of the present invention, the second driving unit comprises a third torque providing portion for providing torque; a second operation shaft coupled to the third torque providing portion and inserted into the second hole of the transfer unit to be coupled to the transfer unit; a third operation shaft disposed in the blocking unit to drive the blocking unit; and a second bevel gear which is disposed at a hinge-coupling portion of the blocking unit and the transfer unit and transmits torque of the second operation shaft to the third operation shaft.

According to the exemplary embodiment of the present invention, the second driving unit comprises a second transmission shaft disposed in a vertical direction to the second operation shaft and extends to an external portion of the housing unit; and a third bevel gear which connects the second transmission shaft and the second operation shaft and transmits torque of the third torque providing portion to the second operation shaft through the second transmission shaft.

According to the exemplary embodiment of the present invention, the third torque providing portion has a handle connected to the second transmission shaft.

According to the exemplary embodiment of the present invention, the second driving unit comprises a third transmission shaft having a different central axis from the second operation shaft and disposed to be coupled to the third bevel gear; and a spur gear for transmitting torque of the second operation shaft to the third transmission shaft.

According to the exemplary embodiment of the present invention, the third operation shaft of the blocking unit is apart from a central axis formed in a longitudinal direction of the housing unit.

According to the exemplary embodiment of the present invention, the pipeline fluid flow blocking device further comprises a measuring means which is coupled to the third torque providing portion and detects a rotation number of the second operation shaft.

According to the exemplary embodiment of the present invention, the blocking unit comprises a plurality of lever members having a bending portion and an insertion cavity in its one side; a plurality of unfolding plates which have one sides which are respectively coupled to the insertion cavities of the lever members and the other sides which are radially expanded centering on a central axis of the blocking unit by a leverage movement of the lever members to closely contact the inner surface of the pipeline to thereby shut off the inside of the pipeline; and a cam member which has a side surface in which a first groove coupled to the other side opposite to one side of the lever member is formed, has a cylindrical shape in which a third hole into which the third operation shaft is insert is formed on a central axis line, and changes a straight line movement by the third operation shaft to a rotation movement centering on the other side of the lever members to make the unfolding plates be expanded or shrunk.

According to the exemplary embodiment of the present invention, the outer side surface of the third operation shaft is screw-coupled to the inner side surface of the third hole.

According to the exemplary embodiment of the present invention, the cam member defines the first groove and is formed such that a first slope of the cam member adjacent to the transfer unit and a second slope facing the first slope form an obtuse angle, and a first angle formed by the first slope and a surface substantially vertical to a central axis of the cam member is greater than a second angle formed by the second slope and the surface, and the lever member is coupled to the cam member so that the outside of the bending portion is adjacent to the first slope.

According to the exemplary embodiment of the present invention, the blocking unit further comprises a head body which has a fourth hole horizontally communicating with the third hole, a second groove for accepting the upper portion or a lower portion of the cam member, and has a cylindrical shape whose one side is opened and a head cover for covering the opened side of the head body and having a cylindrical shape cross section which externally exposes the unfolding plates, the first groove of the cam member is formed in a band form, and one side of the head cover facing the head body has a plurality of third grooves for accepting the lever members so that the lever members have a substantially regular distance there between.

According to the exemplary embodiment of the present invention, the unfolding plate comprises a coupling portion which is disposed in the one side and is coupled to the insertion cavity of the lever member, and a side surface which has an end portion having a third slope which closely contacts the inner side surface of the pipeline and a fourth slope which makes the neighboring unfolding plates closely contact each other when the unfolding plates are radially expanded.

According to the exemplary embodiment of the present invention, the blocking unit further comprises a pad made of an elastic material which is disposed between the unfolding plates and covers a space between the unfolding plates.

In order to achieve the second object, another aspect of the present invention provides a bypass forming system which is formed on a pipeline and bypasses a fluid which flows inside the pipeline substantially in one direction between a first spot of the pipeline and a second spot of the pipeline apart from the first spot in the fluid flowing direction.

In detail, a first device which is disposed at the first spot includes a hollow-type first housing unit which has a cylindrical shape whose one side is opened and communicates with the first spot through the opened one side, a first transfer unit which moves in a longitudinal direction inside the first housing unit, a first driving unit for moving the first transfer unit in a gear method, a first blocking unit which is hinge-coupled to one side of the first transfer unit, is disposed to move between the first housing unit and the inside of the pipeline through the opened one side of the first housing unit by the first transfer unit, and changing a moving path of the fluid from the first spot to the inside of the first housing unit by being radially expanded or shrunk to shut off the inside of the pipeline, and a second driving unit for making the first blocking unit be expanded or shrunk in a gear method.

A second device which is disposed at the second spot of the pipeline includes a hollow-type second housing unit which has a cylindrical shape whose one side is opened and communicates with the second spot through the opened one side, a second transfer unit which moves in a longitudinal direction inside the second housing unit, a third driving unit for moving the second transfer unit in a gear method, a second blocking unit which is hinge-coupled to one side of the second transfer unit, is disposed to move between the second housing unit and the inside of the pipeline through the opened one side of the second housing unit by second first transfer unit, and communicates the inside of the second housing unit, the second spot of the pipeline and a third spot which is apart from the second spot in the fluid flowing direction with each other by being radially expanded or shrunk to shut off the inside of the pipeline, and a fourth driving unit for making the second blocking unit be expanded or shrunk in a gear method.

A bypass pipeline connects the first device and the second device to communicate with the first housing unit of the first device and the second housing unit of the second device.

According to the exemplary embodiment of the present invention, the first blocking unit of the first device is disposed to be expanded toward a second direction which is substantially opposite to a first direction in which a fluid flows inside the pipeline, and the second blocking unit of the second device is expanded toward the first direction in which the fluid flows inside the pipeline.

### ADVANTAGEOUS EFFECTS

As described above, the pipeline fluid flow blocking device of the present invention can stably block the fluid flow during a work for replacing, transferring or repairing the pipeline which transfers a fluid such as a water or sewer pipeline, a gas pipeline and an oil pipeline. Therefore, a time and cost required in the work can be greatly reduced.

Using the bypass forming system 500 of the present invention, works for replacing, transferring and repairing the pipeline can be easily performed without suspending a fluid which flows inside the pipeline. Therefore, a social loss cost resulting from water or gas supply suspension can be minimized because water or gas supply is not suspended by the works.

### BRIEF DESCRIPTION OF THE DRAWINGS

FIGS. 1 and 14 are schematic diagrams illustrating a pipeline fluid flow blocking device according to an exemplary embodiment of the present invention;

FIG. 2 is a partial enlarged view illustrating a first driving unit shown in FIG. 1 in more detail;

FIG. 3 is a partial enlarged view illustrating a lower portion of a transfer unit shown in FIG. 1;

FIG. 4 is a cross-sectional view illustrating a blocking unit shown in FIG. 1;

FIG. 5 is a perspective view illustrating the blocking unit shown in FIG. 1;

FIG. 6 is a perspective view schematically illustrating a lever member and an unfolding plate shown in FIG. 4;

FIG. 7 is a cross-sectional view illustrating a head body shown in FIG. 4;

FIG. 8 is a bottom view illustrating the head body shown in FIG. 4;

FIG. 9 is a cross-sectional view illustrating a head cover shown in FIG. 4;

FIG. 10 is a bottom view illustrating the head cover shown in FIG. 4;

FIG. 11 is a bottom view illustrating a state that the unfolding plates shown in FIG. 5 are unfolded;

FIG. 12 is a schematic diagram illustrating a bypass forming system according to the exemplary embodiment of the present invention; and

FIG. 13 is a plane view illustrating the bypass forming system shown in FIG. 12.

### MODE FOR THE INVENTION

A pipeline fluid flow blocking device and a bypass forming system using the same according to an exemplary embodiment of the present invention will be described with attached drawings. However, the present invention is not limited to the below exemplary embodiment and can be variously modified by a person having ordinary skill in the art within the scope of the present invention without departing from the technical spirit of the present invention. In the drawings, dimensions of respective components are exaggerated for clarity. In the present invention, if it is stated that one component is formed “on”, “above” or “below” the other component, it means that one component is formed above or below the other component, and an additional component may be located on the other component. Also, indicating respective components by terms “first”, “second”, “third”, “fourth” and/or “fifth” is not to limit those components but to distinguish one component from another. Therefore, the terms “first”, “second”, “third”, “fourth” and/or “fifth” can be selectively or alternately used for the respective components.

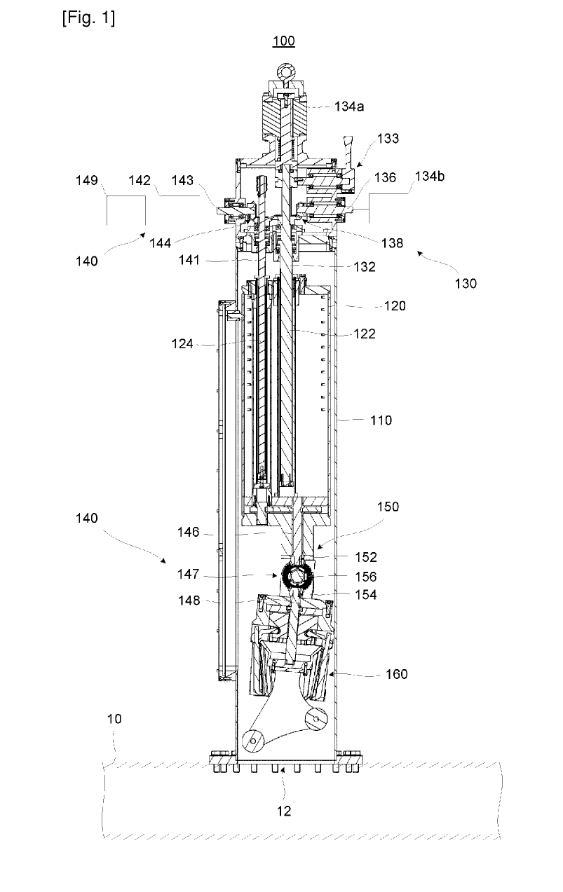

FIG. 1 is a schematic diagram illustrating a pipeline fluid flow blocking device according to an exemplary embodiment of the present invention.

Referring to FIG. 1, the pipeline fluid flow blocking device 100 comprises a housing unit 110, a transfer unit 120 which is movable in the housing unit 110, a first driving unit 130 for moving the transfer unit 120, a blocking unit 140 which is hinge-coupled to one side of the transfer unit and is radially expanded or shrunk to shut off the inside of a pipeline 10, and a second driving unit 140 for making the blocking unit 160 be radially expanded or shrunk.

First, an opening 12 is formed in the pipeline 10 by using a predetermined punching device (not shown). The fluid flow is blocked in both sides of the pipeline 10 which is a target of a work for replacing, transferring or repairing the pipeline 10, and the work is performed in the blocked section. The pipeline fluid flow blocking device 100 according to the exemplary embodiment of the present invention is inserted through each of the openings which are formed at two spots to block the fluid flow, and the device 100 can be installed at one spot or two or more spots.

The housing unit 110 has a hollow cylindrical shape whose one side is opened. The one side of the housing unit 110 is coupled such that the inside of the housing unit 110 is communicated with the pipeline 10. For example, the housing unit 110 may be disposed substantially vertically to the pipeline 10 as shown in FIG. 1. The fluid flow blocking device 110 of the present invention is described as being vertically coupled to the pipeline 10.

The transfer unit 120 may have a cylindrical shape to easily move inside the housing unit 110. Since the blocking unit 160 is coupled to one side of the transfer unit 120, the transfer unit 120 substantially functions to transfer the blocking unit 160, and also functions to suppress shaking when it moves up or down by the first driving unit 130 and functions as a housing in which some components of the second driving unit 140 are mounted to transfer power to the blocking unit 160.

For example, the transfer unit 120 may have a cylindrical shape and may include a first hole 122 which penetrates in its longitudinal direction and has its inner surface with a screw thread formed thereon or a first transfer shaft having the first hole 122. The first hole 122 may be disposed on a central axis line formed in a longitudinal direction of the housing unit 110. A first screw-shaped operation shaft 132 is inserted into the first hole 122 of the transfer unit 120, and the transfer unit 120 is screw-coupled to the first operation shaft 132 through the first hole 122. Therefore, as the first operation shaft 132 rotates in one direction, the transfer unit 120 moves up or down.

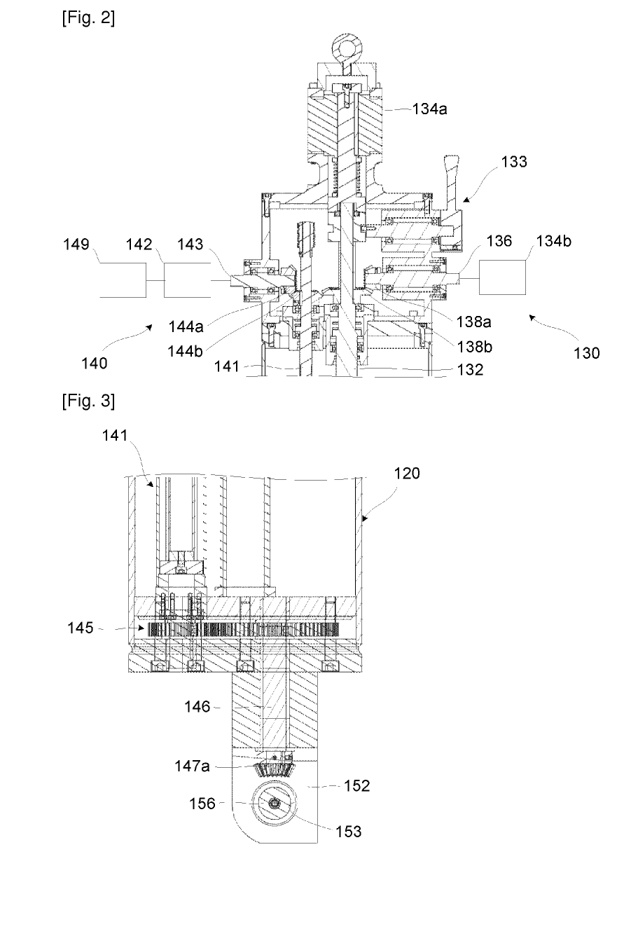

FIG. 2 is a partial enlarged view illustrating the first driving unit shown in FIG. 1 in more detail.

Referring to FIGS. 1 and 2, the first operation shaft 132 is rotated by rotation driving force generated from a first torque providing portion 134a disposed in one side of the housing unit 110. A decelerating motor may be used as the first torque providing portion 134a. A first transmission shaft 136 disposed in a substantially vertical direction to the first operation shaft 132 may be coupled to one side of the housing unit 110. At this time, the first transmission shaft 136 is preferably coupled to a second torque providing portion 134b disposed apart from the first torque providing portion 134a. Here, the second torque providing portion 134b preferably includes a handle for manually rotating the first transmission shaft 136. First bevel gears 138a and 138b may be installed in the first transmission shaft 136 and the first operation shaft 132, respectively. Torque of the second torque providing portion 134b may be transmitted to the first operation shaft 132 through the first transmission shaft 136 and the first bevel gears 138a and 138b.

As described above, the first operation shaft 132 of the first driving unit 130 is preferably configured to be selectively driven by any of the first torque providing portion 134a and the second torque providing portion 134b. A clutch means 133 for selectively connecting the first torque providing portion 134a and the second torque providing portion 134 to the first operation shaft 142 may be disposed on one side of the housing unit 110. On the contrary, the clutch means 133 may be disposed to connect or separate the first operation shaft 132 to or from the first torque providing portion 134a. At this time, the first operation shaft 132 and the first transmission shaft 136 may be connected regardless of an operation of the clutch means 133. Therefore, when the first torque providing portion 134a is destroyed or does not operate properly, it is replaced with the second torque providing portion 134 by using the clutch means 133. Also, in order to improve work efficiency, the first and second torque providing portions 134 may be alternately used.

Returning to FIG. 1, a second hole 124 which extends in a longitudinal direction of the transfer unit 120 apart from the first hole 122 or a second transfer shaft having the second hole 124 may be formed inside the transfer unit 120. The second driving unit 140 comprises a third torque providing portion 142, second operation shafts 141 and 146, a third operation shaft 148, and a second bevel gear 147.

For example, the third torque providing portion 142 is installed apart from the first and second torque providing portions 134a and 134b and provides torque to the second operation shafts 141 and 146. The third torque providing portion 142 may operate in an electrical method or a manual method, and if it operates in a manual method, a handle through which an operator can appropriately control a revolution number is preferably used like the second torque providing portion 142. The second operation shafts 141 and 146 are inserted into the inside of the second hole 124 to be coupled to the transfer unit 120. The third operation shaft 148 is disposed in the blocking unit 160 below the second operation shafts 141 and 146 to make the blocking unit 160 expanded or shrunk.

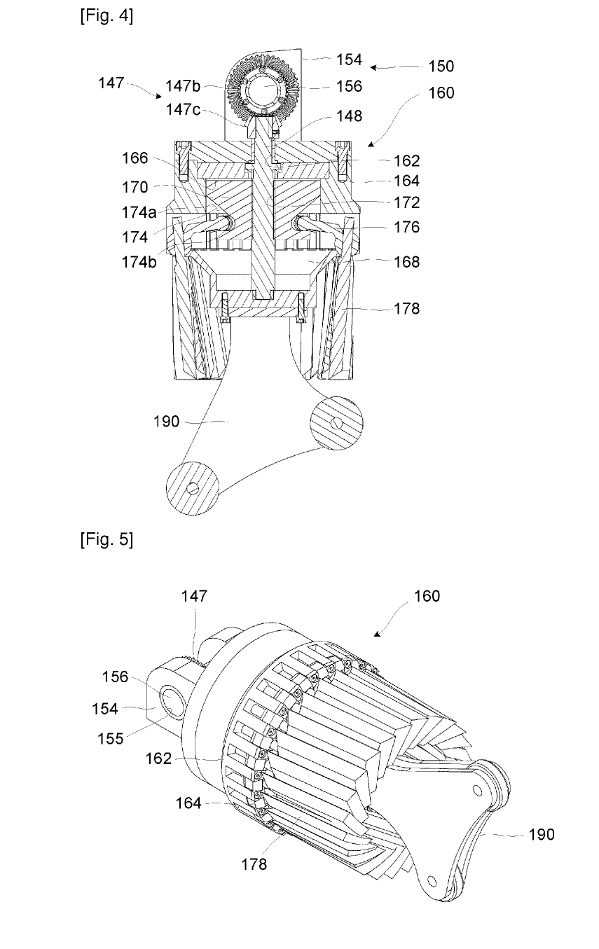

FIG. 3 is a partial enlarged view illustrating a lower portion of the transfer unit shown in FIG. 1, and FIGS. 4 and 5 are a cross-sectional view and a perspective view illustrating the blocking unit shown in FIG. 1, respectively.

Referring to FIG. 3, as the second operation shaft, the upper second operation shaft 141 and the third transmission shaft 146 which has a different central axis from the upper second operation shaft 141 and is coupled to the second bevel gear 147 may be disposed. At this time, the second driving unit 140 preferably includes a spur gear portion 145 for transmitting torque of the upper second operation shaft 141 to the third transmission shaft 146.

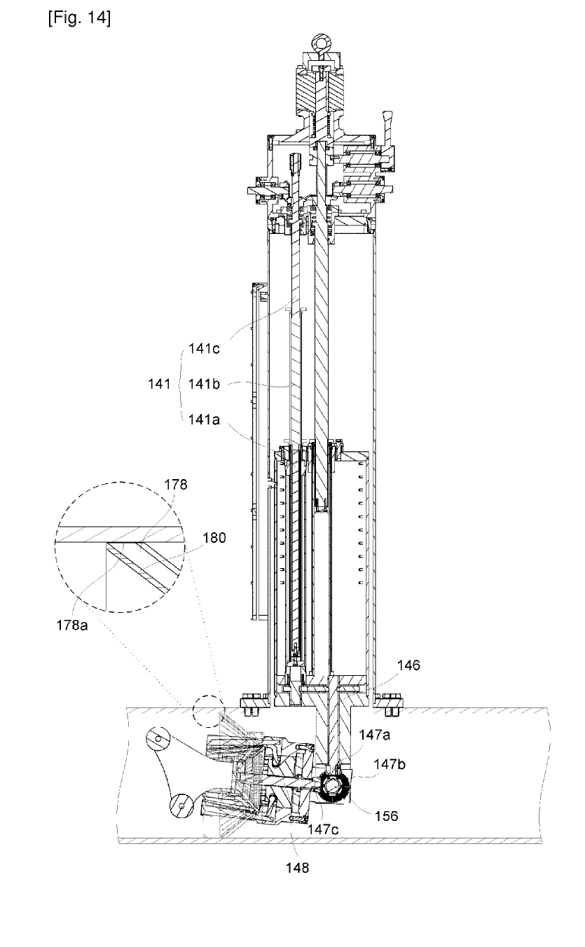

Also, the upper second operation shaft 141 preferably comprises, for example, transfer spindles which have different diameters and have stepped portions therebetween as shown in FIG. 14. For example, even though not shown in detail, the upper second operation shaft 141 may comprise a first spindle 141a which is key-coupled to a worm gear of the spur gear portion 145 and rotates to drive the spur gear portion 145, and a second spindle 141b which is key-coupled to the inside of the first spindle 141a to perform rotation and front and rear transfer. The upper second operation shaft 141 may comprise spindles 141a, 141b and 141c of three or more steps according to the actual size.

Meanwhile, referring to FIGS. 3 to 5, the blocking unit 160 may be rotatably hinge-coupled to one side of the transfer unit 120. For example, in one side of the transfer unit 120, a first connecting member 152 having a first opening 153 into which a rotation shaft 156 is inserted may be formed in a protruded form. Also, in one side of the blocking unit 160 facing the transfer unit 120, a second connecting member 154 having a second opening 155 corresponding to the first opening 153 may be formed in a protruded form. That is, the first connecting member 152 and the second connecting member 154 are hinge-coupled to be rotatable centering on the rotation shaft 156 inserted into the first and second openings 153 and 155.

Returning to FIGS. 1 to 5, the second operation shafts 141 and 146 and the third operation shaft 148 may be connected by the second bevel gears 147a, 147b and 147c. Here, the second bevel gears 147a, 147b and 147c are preferably installed at a hinge-coupling portion 150 of the blocking unit 160 and the transfer unit 120 with the same central axis as the rotation shaft 156. It is because even though the blocking unit 160 is bent to rotates left and right inside the pipeline 10, since the central axis of the rotation shaft 156 does not swerve, torque of the second operation shafts 141 and 146 can be stably transmitted to the third operation shaft 148 by the second bevel gears 147a, 147b and 147c, as shown in FIG. 14.

For example, as shown in the drawings, the upper second bevel gear 147a and the lower second bevel gear 147c may be bevel gear-coupled centering on the intermediate second bevel gear 147b between the third transmission shaft 146 of the second operation shaft and the third operation shaft. Meanwhile, if the second driving unit 140 is used, for the sake of work convenience, a measuring means for detecting a rotation number of the third torque providing portion 142 is preferably installed.

Meanwhile, referring to FIG. 2, a second transmission shaft 143 which is disposed in an actually vertical direction to the second operation shaft 141 to be connected to the second torque providing portion 142 may be coupled to the other side of the housing unit 110. Third bevel gears 144a and 144b may be installed in the second transmission shaft 143 and the second operation shaft 141, respectively. Therefore, torque of the third torque providing portion 142 can be transmitted to the second operation shaft 141 through the second transmission shaft 143 and the third bevel gears 144a and 144b.

Next, the blocking unit 160 will be described in more detail with reference to FIGS. 4 and 5. The blocking unit 160 may comprise a plurality of lever members 176, a plurality of unfolding plates 178 which are radially expanded by a leverage movement of the lever members 176 to shut off the inside of the pipeline 10, and a cam member 170 for making the unfolding plates 178 expanded or shrunk by changing a straight line movement to a rotation movement of the lever members 176.

In detail, the cam member 170 has a cylindrical shape in which a third hole 172 into which the third operation shaft 148 is inserted is formed on a central axis line, and performs a straight line movement along the central axis by the third operation shaft 148. For example, even though not shown, a straight line movement of the cam member 170 may be implemented by a screw coupling of the third operation shaft 148 and the third hole 172. That is, the cam member 170 moves forward or backward by rotation of the third operation shaft 148. Also, a first groove 174 is formed on a side circumference of the cam member 170. One side of the lever member 176 is coupled to the first groove 174, so that a straight line movement of the cam member 170 is changed to a rotation movement which rotates centering on the one side.

For example, the cam member 170 defines the first groove 174 and comprises a first slope 174a adjacent to the hinge-coupling portion 150 and a second slope 174b facing the first slope 174a. Preferably, the first slope 174a and the second slope 174b form an acute angle, and an angle which the first slope 174a and a surface substantially vertical to a central axis of the cam member 170 form is larger than the second slope 174b and the surface form. Therefore, when the lever member 176 is coupled to the cam member 170 such that the outside of a bending portion 176a is adjacent to the first slope 174a, a rotation angle of the lever member 176 can be sufficiently formed by a forward movement of the cam member 170.

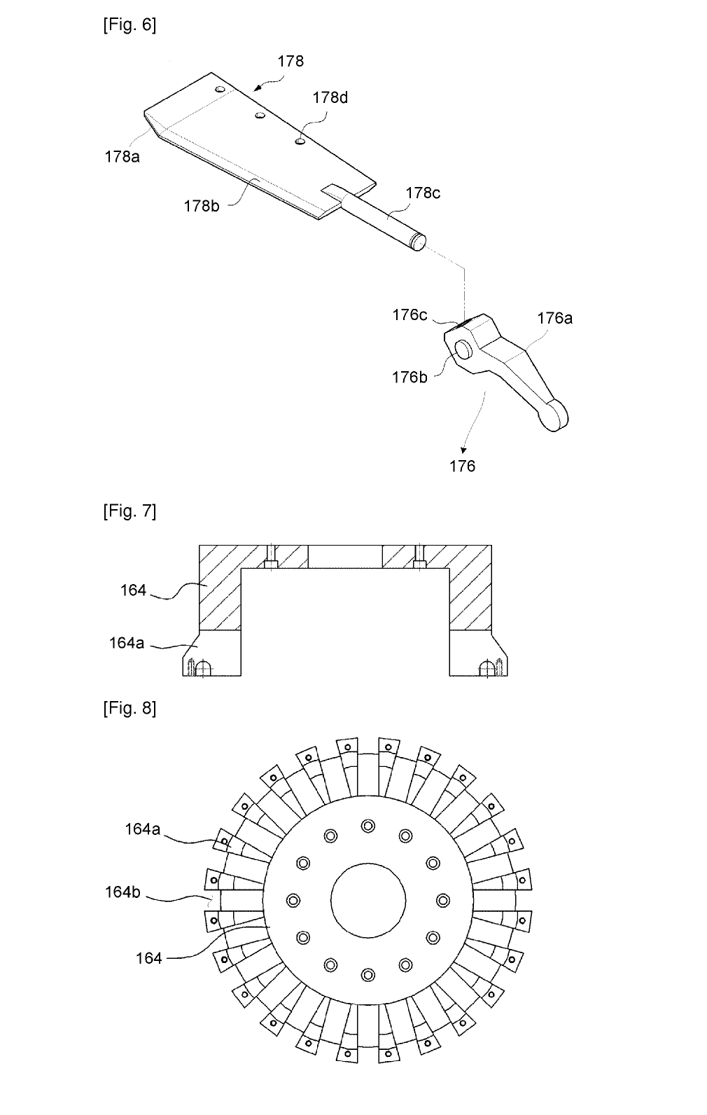

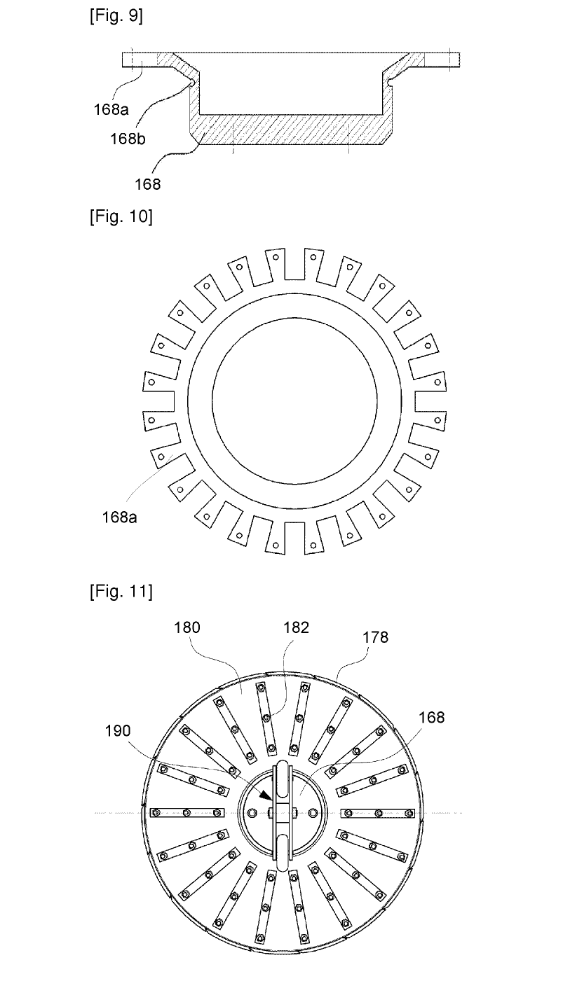

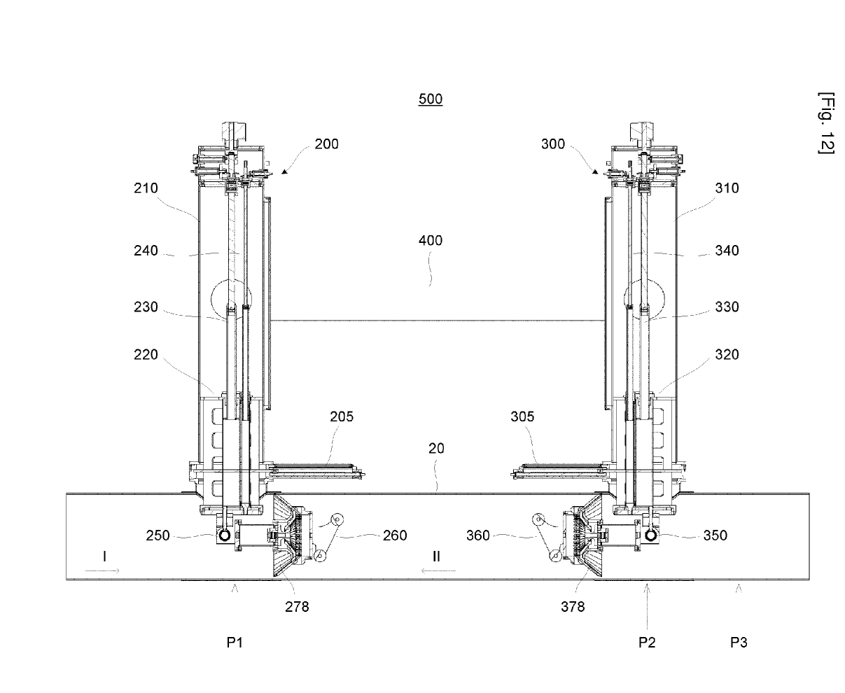

FIG. 6 is a perspective view schematically illustrating the lever member and the unfolding plate shown in FIG. 4, FIGS. 7 and 8 are a cross-sectional view and a bottom view illustrating a head body shown in FIG. 4, and FIGS. 9 and 10 are a cross-sectional view and a bottom view illustrating a head cover shown in FIG. 4.

Referring to FIGS. 4 and 6, in the blocking unit 160, a head body 164 and the cam member 170 are coupled to a lower portion of the hinge-coupling portion 150 through the third operation shaft 148. For example, the head body 164 comprises a fourth hole 162 which horizontally communicates with the third hole 172 and a second groove 166 for accepting a lower portion of the cam member 170 and has a cylindrical shape whose lower portion is opened. A head cover 168 of a corresponding shape to the head body 164 is coupled to a lower portion of the head body 164. A plurality of lever members 176 are rotatably coupled between the head body 164 and the head cover 168. The lever member 176 is inserted into the first groove 174 of the cam member 170.

The lever member 176 has a bending portion 176a and an insertion cavity 176c formed in its one end. A single shaft 176b is formed on an end of the lever member 176 in which the insertion cavity 176c is formed. The unfolding plate 178 is coupled to the lever member 176, and a pad (not shown) is mounted on the head cover 168. Meanwhile, a guide member 190 may include, for example, two rollers, and one roller of a direction that the blocking unit 160 is bent is preferably disposed to more protrude than the other roller.

In more detail, the head body 164 may have a shape that a circular edge having the predetermined thickness protrudes downwardly as shown in FIG. 7. Also, the head body 164 is formed such that a plurality of lever support protrusions 164a are disposed at a substantially regular interval along the edge as shown in FIG. 8. Also, a third groove 164b is formed in each of the lever support protrusions 164a of the head body 164.

The head cover 168 has a shape for protruding upwardly along a circular edge as shown in FIG. 9, and a second lever support protrusion 168a is formed along the circular edge as shown in the plane view of FIG. 10.

Returning to FIGS. 6 and 9, the lever member 176 is located between the head body 164 and the head cover 168, i.e., in each of spaces between the first and second lever support protrusions 164a and 168a which are adjacent to each other. That is, the lever members 176 are radially disposed on a plane. The single shaft 176b of each lever member 176 may be supported by being caught by the inside of the fourth groove 168b of the second lever support protrusion 168a of the head cover 168. Therefore, each lever member 176 is fixed between the head body 164 and the head cover 168 through the single shaft 176b, but since it is located in a space formed between the first and second lever support protrusions 164a and 168a, it can rotate centering on the single shaft 176b.

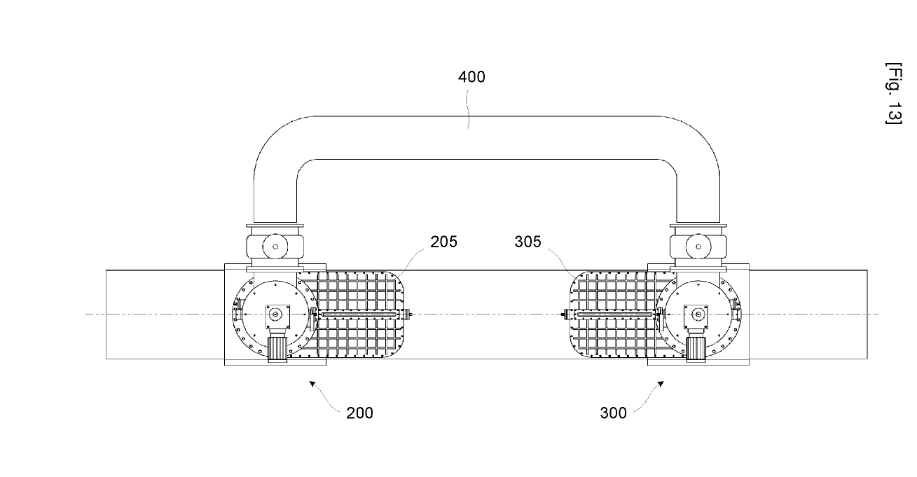

Meanwhile, referring to FIG. 6, a coupling portion 178c which is a shaft of the unfolding plate 178 is disposed to be inserted into the insertion cavity 176c of the lever member 176. The unfolding plate 178 has a third slope 178a so that the outside of the unfolding plate 178 can closely contacts the inner side surface of the pipeline 10 when the unfolding plates 178 are expanded as shown in FIG. 14. Also, as shown in FIG. 11, the unfolding plate 178 further has a fourth slope 178b so that side surfaces of the neighboring unfolding plates 178 can closely contact each other when the unfolding plates 178 are expanded. Therefore, when the unfolding plates 178 are substantially completely expanded, the flow of the fluid which flows in the pipeline can be efficiently blocked.

FIG. 11 is a bottom view illustrating a state that the unfolding plates shown in FIG. 5 are unfolded.

Referring to FIG. 11, a pad 180 made of an elastic material for covering a fine space between the neighboring unfolding plates 178 is preferably disposed to improve blocking efficiency. For example, the pad 180 may have a disc shape and is coupled to the unfolding plate 178 by a coupling member 182 such as a screw. A coupling hole 178d corresponding to the coupling member 182 is formed in the unfolding plate 178. Also, the pad 180 needs to be formed to completely shut off a fine gap between the inner surface of the pipeline 10 and the unfolding plate 178 when the unfolding plate 178 is completely unfolded. Therefore, the pad 180 has preferably the longer length than the unfolding plate 178.

FIG. 12 is a schematic diagram illustrating a bypass forming system according to the exemplary embodiment of the present invention, and FIG. 13 is a plane view illustrating the bypass forming system shown in FIG. 12.

Referring to FIG. 13, let us assume that a fluid substantially flows inside the pipeline in one direction I. The bypass forming system 5000 of the present invention includes a first device 200 for blocking the fluid flow of the pipe inside at a first spot P1 of the pipeline 20. Also, a second device 300 is installed, facing the first device 200, at a second spot P2 of the pipeline 20 which is apart from the first spot P1 in the fluid flowing direction I. A bypass pipeline 400 is disposed to connect the first device 200 and the second device 300.

Here, it is important for the first and second devices 200 and 300 to shut off a portion of the pipeline 20 between the first spot P1 and the second spot P2 without suspending the fluid flow. The insides of the first device 200, the bypass pipeline 400 and the second device 300 communicate with the pipeline 20 so that a fluid which starts from the left of the pipeline 20 can be bypassed through the insides of the first device 200, the bypass pipeline 400 and the second device 300.

For example, the first device 100 has a cylindrical shape whose one end is opened and includes a hollow-type first housing unit 210 in which the opened one side communicates with the first spot, a first transfer unit 220 which moves in a longitudinal direction inside the first housing unit 210, and a first driving unit 230 which moves the first transfer unit 220 by using a gear method.

A first blocking unit 260 of the first device 100 is hinge-coupled to one side of the first transfer unit 230, is disposed to move between the first housing unit 210 and the inside of the pipeline 20 through the opened one side of the first housing unit 210 by the first transfer unit 220, and is radially expanded or shrunk to shut off the inside of the pipeline 20 to change the moving path of the fluid to the inside of the first housing unit 210 from the first spot P1. The first blocking unit 260 operates to be expanded or shrunk in a gear method by a second driving unit 240.

Meanwhile, the second device 300 is installed at the second spot P2 of the pipeline 20, has a cylindrical shape whose one side is opened, and includes a hollow-type second housing unit 310 in which the opened one side communicates with the second spot, a second transfer unit 320 which moves in a longitudinal direction inside the second housing unit 310, and a third driving unit 330 which moves the second transfer unit 320 by using a gear method.

A second blocking unit 360 is hinge-coupled to one side of the second transfer unit 330, is disposed to move between the second housing unit 310 and the inside of the pipeline 20 through the opened one side of the second housing unit 310 by the second transfer unit 320, and is radially expanded or shrunk to shut off the inside of the pipeline 20. That is, the second blocking unit 360 communicates the inside of the second housing unit 310, the second spot P2 of the pipeline 20 and a third spot P3 which is apart from the second spot P2 in a fluid flowing direction with each other. A fourth driving unit 340 operates to make the second blocking unit 360 expanded or shrunk in a gear method.

Meanwhile, the bypass pipeline 400 is coupled to communicate the hollow-type first housing unit 210 of the first device 200 with the second housing unit 310 of the second device 300. The above-mentioned components are similar or same as those of the pipeline fluid flow blocking device 100 of the present invention which have been described with reference to FIGS. 1 to 11 and FIG. 14, and thus detailed descriptions on them will be omitted.

Here, the first blocking unit 260 of the first device 200 is coupled to a first hinge coupling portion 250 to be expanded toward a second direction II which is substantially opposite to the first direction I in which a fluid flows inside the pipeline 20. Similarly, the second blocking unit 360 of the second device 300 has to be coupled to a second hinge coupling portion 250 to be expanded toward the first direction I in which a fluid flows inside the pipeline 20.

If the first device 200 is compared to the fluid flow blocking device 100 of the present invention, the expanding direction of the first unfolding plate 278 of the first blocking unit 260 is opposite to the expanding direction of the unfolding plate 178 of the fluid flow blocking device 100. Also, the first transfer unit 220 forms a space in which a fluid moves unlike the fluid flow blocking device 120.

Meanwhile, in the first and second devices 200 and 300, first and second shutter members 205 and 305 for opening or shutting off the first and second housing units 210 and 310 in a cross-sectional direction may be further included.

Using the bypass forming system 500 having the above-described configuration, works for replacing, transferring and repairing the pipeline can be easily performed without suspending a fluid which flows inside the pipeline. Therefore, a social loss cost resulting from water or gas supply suspension does not occur because water or gas supply is not suspended by the works.

The preferred embodiment of the present invention has been disclosed in this specification and the drawings. Even though certain terms have been used, these are used as general meanings to easily transfer and help understand the technology of the present invention and are not intended to limit the scope of the present invention. In addition to the exemplary embodiment disclosed herein, modifications based on the technical spirit of the present invention can be made by a person having ordinary skill in the art to which the present invention pertains.

### INDUSTRIAL APPLICABILITY

The pipeline fluid flow blocking device of the present invention can be easily used in a work for blocking the fluid flow during a work for replacing, transferring or repairing the pipeline which transfers a fluid such as a water or sewer pipeline, a gas pipeline and an oil pipeline.

1. A pipeline fluid flow blocking device, comprising:
a hollow housing unit having a cylindrical shape whose one side is opened and being coupled to a pipeline to communicate with the pipeline in the one side;
a transfer unit for moving in a longitudinal direction of the housing unit inside the housing unit;
a first driving unit for moving the transfer unit by using a gear method;
a blocking unit which is hinge-coupled to one side of the transfer unit, is disposed to move between the housing unit and the inside of the pipeline through the opened one side of the housing unit by the transfer unit, and is radially expanded or shrunk to shut off the inside of the pipeline; and
a second driving unit for performing expanding or shrinking of the blocking unit in a gear method.

2. The pipeline fluid flow blocking device of claim 1, wherein the transfer unit has a first hole which extends in a longitudinal direction of the transfer unit and has a screw thread formed in its inner surface.

3. The pipeline fluid flow blocking device of claim 2, wherein the first driving unit comprises
a first operation shaft of a screw form which extends in a longitudinal direction of the housing unit and is inserted into the first hole of the transfer unit to move the transfer unit by a screw-thread coupling; and
a first torque providing portion for rotating the first operation shaft.

4. The pipeline fluid flow blocking device of claim 3, wherein the first torque providing portion comprises a decelerating motor.

5. The pipeline fluid flow blocking device of claim 3, wherein the first driving unit comprises
a second torque providing portion disposed apart from the first torque providing portion;
a first transmission shaft coupled to the second torque providing portion and disposed in a vertical direction to the first operation shaft; and
a first bevel gear for connecting the first transmission shaft and the first operation shaft and transmitting torque generated by the second torque providing portion to the first operation shaft through the first transmission shaft.

6. The pipeline fluid flow blocking device of claim 5, further comprising, a clutch means which is coupled to the first operation shaft and connects or separates the first operation shaft to or from the first torque providing portion.

7. The pipeline fluid flow blocking device of claim 3, wherein the first hole of the transfer unit and the first operation shaft are disposed on a central axis line formed in a longitudinal direction of the housing unit.

8. The pipeline fluid flow blocking device of claim 3, wherein the transfer unit has a second hole which is apart from the first hole and extends in a longitudinal direction of the transfer unit.

9. The pipeline fluid flow blocking device of claim 8, wherein the second driving unit comprises
a third torque providing portion for providing torque;
a second operation shaft coupled to the third torque providing portion and inserted into the second hole of the transfer unit to be coupled to the transfer unit;
a third operation shaft disposed in the blocking unit to drive the blocking unit; and
a second bevel gear which is disposed at a hinge-coupling portion of the blocking unit and the transfer unit and transmits torque of the second operation shaft to the third operation shaft.

10. The pipeline fluid flow blocking device of claim 9, wherein the second driving unit comprises
a second transmission shaft disposed in a vertical direction to the second operation shaft and extends to an external portion of the housing unit; and
a third bevel gear which connects the second transmission shaft and the second operation shaft and transmits torque of the third torque providing portion to the second operation shaft through the second transmission shaft.

11. The pipeline fluid flow blocking device of claim 10, wherein the third torque providing portion has a handle connected to the second transmission shaft.

12. The pipeline fluid flow blocking device of claim 9, wherein the second driving unit comprises
a third transmission shaft having a different central axis from the second operation shaft and disposed to be coupled to the third bevel gear; and
a spur gear for transmitting torque of the second operation shaft to the third transmission shaft.

13. The pipeline fluid flow blocking device of claim 9, wherein the third operation
shaft of the blocking unit is apart from a central axis formed in a longitudinal direction of the housing unit.

14. The pipeline fluid flow blocking device of claim 9, further comprising, a measuring means which is coupled to the third torque providing portion and detects a rotation number of the second operation shaft.

15. The pipeline fluid flow blocking device of claim 9, wherein the blocking unit comprises
a plurality of lever members having a bending portion and an insertion cavity in its one side;
a plurality of unfolding plates which have one sides which are respectively coupled to the insertion cavities of the lever members and the other sides which are radially expanded centering on a central axis of the blocking unit by a leverage movement of the lever members to closely contact the inner surface of the pipeline to thereby shut of the inside of the pipeline; and
a cam member which has a side surface in which a first groove coupled to the other side opposite to one side of the lever member is formed, has a cylindrical shape in which a third hole into which the third operation shaft is insert is formed on a central axis line, and changes a straight line movement by the third operation shaft to a rotation movement centering on the other side of the lever members to make the unfolding plates be expanded or shrunk.

16. The pipeline fluid flow blocking device of claim 15, wherein the outer side surface of the third operation shaft is screw-coupled to the inner side surface of the third hole.

17. The pipeline fluid flow blocking device of claim 15, wherein the cam member defines the first groove and is formed such that a first slope of the cam member adjacent to the transfer unit and a second slope facing the first slope form an obtuse angle, and a first angle formed by the first slope and a surface substantially vertical to a central axis of the cam member is greater than a second angle formed by the second slope and the surface, and the lever member is coupled to the cam member so that the outside of the bending portion is adjacent to the first slope.

18. The pipeline fluid flow blocking device of claim 15, wherein the blocking unit further comprises a head body which has a fourth hole horizontally communicating with the third hole, a second groove for accepting the upper portion or a lower portion of the cam member, and has a cylindrical shape whose one side is opened and a head cover for covering the opened side of the head body and having a cylindrical shape cross section which externally exposes the unfolding plates, the first groove of the cam member is formed in a band form, and one side of the head cover facing the head body has a plurality of third grooves for accepting the lever members so that the lever members have a substantially regular distance there between.

19. The pipeline fluid flow blocking device of claim 15, wherein the unfolding plate comprises a coupling portion which is disposed in the one side and is coupled to the insertion cavity of the lever member, and a side surface which has an end portion having a third slope which closely contacts the inner side surface of the pipeline and a fourth slope which makes the neighboring unfolding plates closely contact each other when the unfolding plates are radially expanded.

20. The pipeline fluid flow blocking device of claim 15, wherein the blocking unit further comprises a pad made of an elastic material which is disposed between the unfolding plates and covers a space between the unfolding plates.

21. A bypass forming system which is formed on a pipeline and bypasses a fluid which flows inside the pipeline substantially in one direction between a first spot of the pipeline and a second spot of the pipeline apart from the first spot in the fluid flowing direction, comprising:
a first device which is disposed at the first spot and includes a hollow-type first housing unit which has a cylindrical shape whose one side is opened and communicates with the first spot through the opened one side, a first transfer unit which moves in a longitudinal direction inside the first housing unit, a first driving unit for moving the first transfer unit in a gear method, a first blocking unit which is hinge-coupled to one side of the first transfer unit, is disposed to move between the first housing unit and the inside of the pipeline through the opened one side of the first housing unit by the first transfer unit, and changing a moving path of the fluid from the first spot to the inside of the first housing unit by being radially expanded or shrunk to shut off the inside of the pipeline, and a second driving unit for making the first blocking unit be expanded or shrunk in a gear method;
a second device which is disposed at the second spot of the pipeline and includes a hollow-type second housing unit which has a cylindrical shape whose one side is opened and communicates with the second spot through the opened one side, a second transfer unit which moves in a longitudinal direction inside the second housing unit, a third driving unit for moving the second transfer unit in a gear method, a second blocking unit which is hinge-coupled to one side of the second transfer unit, is disposed to move between the second housing unit and the inside of the pipeline through the opened one side of the second housing unit by second first transfer unit, and communicates the inside of the second housing unit, the second spot of the pipeline and a third spot which is apart from the second spot in the fluid flowing direction with each other by being radially expanded or shrunk to shut off the inside of the pipeline, and a fourth driving unit for making the second blocking unit be expanded or shrunk in a gear method; and
a bypass pipeline for connecting the first device and the second device to communicate with the first housing unit of the first device and the second housing unit of the second device.

22. The bypass forming system of claim 21, wherein the first blocking unit of the first device is disposed to be expanded toward a second direction which is substantially opposite to a first direction in which a fluid flows inside the pipeline, and the second blocking unit of the second device is expanded toward the first direction in which the fluid flows inside the pipeline.
